(19) United States
(12) Patent Application Publication
(10) Pub. No.: US 2002/0035531 A1
(43) Pub. Date: Mar. 21, 2002

(54) Common margin settlement vehicle and method of margining exchange-traded futures contracts

(76) Inventor: Robert C. Push, Plainsboro, NJ (US)

Correspondence Address: PROSKAUER ROSE, 1585 BROADWAY, NEW YORK, NY, 100368299

(21) Appl. No.: 09/930,124

(22) Filed: Aug. 14, 2001

Related U.S. Application Data
(60) Provisional application No. 60/225,183, filed on Aug. 14, 2000.

(51) Int. Cl. G06F 17/60

(52) U.S. Cl. 705/36

(57) ABSTRACT

A money market mutual fund and a method for improving the efficiency of margining exchange-traded futures and options contracts is described. Shares of at least one mutual find are purchased by a futures commission merchant (FCM) on behalf of itself or its customer. The FCM then transfers or pledges at least a portion of the shares to an associated clearinghouse to satisfy a margin requirement for a futures or options contract. The margin requirement, for example, may be for original margin, variation margin, or both.

### RELATED APPLICATION

This application is based upon provisional application Ser. No. 60/225,183, entitled “COMMON MARGIN SETTLEMENT VEHICLE,” filed on Aug. 14, 2000 for Robert C. Push. The contents of this provisional application are fully incorporated herein by reference.

### FIELD OF THE INVENTION

The present invention relates to a fund and to a method for improving the efficiency of margining exchange-traded futures and options on futures contracts. More specifically, the present invention relates to a fund, such as a 17 C.F.R. §1.125 regulated money market mutual fund, and to a method of purchasing shares of the fund and transferring the shares to a clearing organization to satisfy a futures margin requirement.

### BACKGROUND OF THE INVENTION

Overview of the Exchange-Traded Futures Industry

A futures contract is a legally binding agreement to buy or sell a commodity or financial instrument, in a designated future month, at a price agreed upon today by a buyer (i.e., the party going “long”) and a seller (i.e., the party going “short”). Futures contracts are standardized according to the quality, quantity, delivery time, and location for each commodity. A future is part of a class of securities called derivatives, which derive their value from the worth of an underlying investment. A futures contract differs from an option to a futures contract, since an option is the “right” to buy or sell, while a futures contract is the promise or obligation to actually make a transaction.

Each time a futures contract or an options contract on futures is entered into, the parties to the contract are required to post collateral to insure their financial performance during the term of the contract. For “exchange-traded” futures, the posting of one type of collateral is referred to as “original margin.” An exchange is a marketplace in which shares, options and futures on stocks, bonds, commodities, and indexes are traded. Principal U.S. stock exchanges include the New York Stock Exchange (NYSE), the American Stock Exchange (AMEX), and the National Association of Securities Dealers Automatic Quotation System (Nasdaq). In particular, futures contracts are traded on exchanges such as the Chicago Board of Trade, the Chicago Mercantile Exchange, the New York Board of Trade, the New York Mercantile Exchange and its COMEX Division, the London International Financial Futures Exchange, and EUREX.

In addition, there is at least twice daily (depending on volatility) “marked-to-market” calculation of gains and losses on open futures positions. Marked-to-market refers to an arrangement whereby the profits or losses on a futures contract are settled at least once per day. As there are two parties taking opposite positions on each futures contract, the gains and losses equal each other. A clearing organization (or clearinghouse) is an adjunct to its associated futures exchange through which transactions executed on its floor are settled. For simplicity, the terms clearing organization, clearinghouse, and futures exchange will be used synonymously herein. A clearing organization is also charged with adhering to strict delivery procedures. The clearinghouse will collect the amount from each party who has a marked-to-market loss on their position and pays the amount of the loss to the other party of the contact (as a gain). This process is referred to as variation margin. The total variation margin collected, during a variation margin cycle, is equal to the amount of variation margin paid. That is, for every dollar collected for the variation margin, the clearinghouse pays out an equal dollar amount. However, the original margin is collected in the event that a party to a futures contract fails to meet a variation margin payment. Original and variation margins will be described in greater detail below.

Exchanges will only allow a pre-approved counterparts to clear (i.e., settle) futures contracts. These approved counterparts are “clearing members” of the exchanges' clearinghouse. A clearing member is a member firm of an associated clearinghouse and must employ individuals who are members of the associated exchange (or have individual members bestow their privileges to the member firm). Thus, individual members of an exchange are not necessarily “clearing members.” Under current rules, all trades of a non-clearing member must be registered with, and eventually settled through, a clearing member. A specific type of clearing member that relates to futures is a futures commission merchant (FCM). An FCM is a firm or person engaged in soliciting or accepting and handling orders for the purchase or sale of futures contracts, subject to the rules of a futures exchange. Further FCMs, in connection with such solicitation or acceptance of orders, accepts money or securities to provide margin for any resulting trades or contracts. The FCM must be licensed by the Commodity Futures Trading Commission (CFTC). The CFTC is a U.S. government agency, created by Congress in 1974, to regulate exchange-trading in futures (just as the Security and Exchange Commission regulates exchange-trading in equity securities). Note that the terms clearing member and FCM will be used synonymously herein. Further, although there are clearing and non-clearing FCMs, only clearing FCMs will be discussed herein. Examples of FCMs include Merrill Lynch & Co., Inc., Goldman Sachs Group, Inc., and Morgan Stanley Dean Witter & Co.

Any individual or entity that wishes to trade a futures contract or an option on a futures contract must do so through an exchange member and the trade must settle through a clearing member, under current law. Clearing members collect all original margins from its customers, hold these original margins on an omnibus basis (i.e., commingle original margins from many customers), and post it to the exchange, when required, to guarantee the financial performance of its customers. These clearing members may also trade futures for themselves and are also required to post original margin to guarantee their own financial performance.

Overview of the Margin Settlement Process

In general, futures contracts settle on the business day after trade date. This is known as the “settlement date.” When a futures contract is entered into, the clearing member, executing the futures trade either for itself or a non-exchange member (i.e., for its customer), will indicate on a trading ticket the clearinghouse who will be responsible for settling the trade. Once the selected clearinghouse has allocated (i.e., settled) the trade, the clearing member becomes responsible for the financial performance required under the terms of the futures contract. That is, the clearing member becomes legally responsible for the margin settlements. After the close of trading, the clearinghouse will complete the process of allocating all the day's futures trades to the involved clearing members. Trade allocation is reported to the clearing member during the early morning hours of the day following the trade. The clearing member then has a finite amount of time to reconcile allocated trades and, if necessary, notify the clearinghouse of any trade discrepancies. Reconciliation involves the clearinghouse's procedures to collect any required margins from the clearing members. Typically, all clearinghouses have similar procedures for handling reconciliation. For example, prior to the opening of trading the next day, a clearinghouse will collect the required margins from the appropriate clearing members.

The procedure for collecting margins by clearinghouses is similar to the above described trade allocation procedures. The clearinghouses have a list of approved banks that can handle the margin settlement function. In total, there are approximately five banks that service the majority of clearing members for this function. In general, each clearing member maintains a Demand Deposit Account (DDA) and custody account with an approved margin settlement bank. The banks enter into cash margin settlement agreements with the clearinghouses that permit the clearinghouse to draw on the account of the clearing member. For example, between the hours of 2:00am and 8:30am EST, the clearinghouses send notices to the margin settlement banks with instructions to either debit the clearing member for required margin (a collect) or to credit the clearing member's account the achieved margin (a pay). It is important to note that conventionally these margin settlements are made in the form of cash.

As described briefly above, the collecting of margin settlements includes two components. One component is the collection of an original margin for any new futures contract. The other component is the collection of a variation margin, which is the realized marked-to-market loss on the existing futures contracts. Payment of a variation margin loss is the clearing member's responsibility. The collection from one clearing member and payment to another clearing member of a variation margin by the clearinghouse is based on the net sum of all existing positions (of all customers) of each clearing member. In other words, the clearinghouse will calculate all gains of each clearing member's existing positions and all losses on existing positions, and pay or collect the net difference to the member as appropriate.

As previously stated, the collection and payment of variation margin nets to zero. There is a buyer and a seller for each contract. The marked-to-market gain on the position (an increase in price of the underlying product of the futures contract) is collected, periodically or on-demand, from the seller and paid to the buyer. Conversely, the marked-to-market loss on the position (a decrease in price of the underlying product of the futures contract) is collected from the buyer and paid to the seller.

The original margin is the performance bond for each futures contract. The clearinghouse holds it in the event that a clearing member fails to pay a variation margin call. The amount of original margin collected for each futures contract is typically based on the volatility of the underlying product of the futures contract—the potential for either a price increase or a price decrease in the underlying contract. Clearinghouses will typically collect the original margin equal to the highest three consecutive day price movement. Clearinghouses will calculate each clearing members total margin requirement on either a gross or net basis.

For example, when a clearinghouse uses the gross basis of original margin calculation, it will require the original margin for each contract that the clearing member is responsible for, even if the clearing member is clearing both a buyer and a seller for the same futures contact and in the same amount of contracts. Clearinghouses that use net-basis for calculating original margin requirements will offset identical contracts in which a clearing member is clearing both a buyer and a seller. For example, if a clearing member were responsible for 100 long futures contracts for the purchase of corn and also responsible for 100 short futures contracts for the sale of corn, the clearinghouse would not require an original margin. While the clearinghouse of a futures exchange is the buyer and seller of last resort, it is only obligated to its clearing members, not to the customers of its clearing members. Because in this example the clearing member has equal and opposite positions in the same futures contract, the clearinghouse would never need to process a variation margin payment on these positions because the net gain would always be equal to the net loss of the combined position. Thus, if the customer owning the long futures contract failed to pay a variation margin payment, the clearing member would be responsible to the short customer and would rely on the original margin of the long customer to fund the failed payment. CFTC regulations require that a clearing member collect a margin from both customers even if the clearinghouse does not require the posting of an original margin.

A major part of a clearing member's profitability is the interest income that it generates on the margin balances that customers post with their clearing members to support futures trading. This is described in detail in an article entitled FCM Capital Consideration by Robert C. Push in the October/November 1996 issue of Futures Industry Magazine, a leading trade publication. The contents of this article are fully incorporated herein by reference. As is described, the costs of operating a clearing member has continued to increase with exchange fees, technology development, globalization of the business, and regulation contributing to expenses. Further, there is a continued over-supply of clearing members, which creates ensuing price competition. An additional detriment to the revenue of clearing members has been the general decline of interest rates over the past 15 years.

However, perhaps the greatest detriment to profitability of clearing members relates to who keeps the interest earned. In the past, the clearing members retained the interest earned on their customer's cash balances. Over the last ten years, however, the clearing member now pays its clients interest earned on these cash balances. In particular, the industry standard is to pay customers the yield of the current 90-day U.S. Treasury bill. Clearing members attempt to efficiently manage these cash balances in a effort to earn a rate of return higher than the monthly 90-day U.S. Treasury bill yield, and retain the difference as revenue.

In contrast to clearing members, when a U.S. clearinghouse collects the original margin in the form of cash, it will typically keep the interest earned on these cash balances. The exception to this rule is the Chicago Mercantile Exchange (CME). In 1996, the CME, in partnership with Brown Brothers Harriman & Co., developed the Interest Earning Facility (IEF). The IEF is a commingled investment program organized as an Illinois LLC in which Brown Brothers Harriman & Co. is one investment manager. The CME deposits its clearing members' cash original margin deposits in the IEF and pays the clearing members the interest. The investment management guidelines for the IEF are fashioned similarly to those required by the Securities Exchange Commission for money market mutual funds (see 17 C.F.R. §270.2a-7). The major difference between the IEF guidelines and SEC money market mutual fund guidelines is that the IEF only invests in U.S. Treasury securities. This is because, prior to the Dec. 28, 2000 amendment to 17 C.F.R. §1.25, CFTC rules only permitted clearing members to invest customer funds in, e.g., U.S. Government or municipal backed securities.

Because other clearinghouses do not pay the clearing members any interest on their original margin cash balances, clearing members will substitute other instruments to satisfy their original margin requirements. In other words, after cash from the clearing member has been withdrawn by the margin settlement bank (associated with the clearing member and clearinghouse), the clearing member will typically “pledge” securities to the clearinghouse to meet its original margin. When a security is pledged to a clearinghouse to satisfy an original margin, the ownership of such security stays with the clearing member; however, the clearinghouse has a claim in, and receives the interest benefits of, such pledged securities. These securities and other instruments are generally acceptable for original margin, although acceptance may differ from clearinghouse to clearinghouse. However, the majority of original margins are held in U.S. Treasury bills. In order to have an interest-bearing instrument pledged to the clearinghouse, the clearing member must make a substitution for the cash that it already transferred to the clearinghouse (via the margin settlement bank) by 8:30am. FIG. 1 is a flow chart that illustrates conventional transactions performed to satisfy an original margin.

In step 10, a margin settlement bank, on behalf of the clearing member, debits the clearing member's account in cash for the original margin payment. In Step 20, the margin settlement bank credits the clearinghouse's account, also in cash. Later, the clearing member notifies the clearinghouse that it will pledge a security, such as a U.S. Treasury bill to the clearinghouse, in exchange for the return of the cash deposit, in Step 30. In Step 40, the clearinghouse authorizes the return of the cash from its account to the clearing member's account, in Step 45. Of course, although only one clearing member is shown, both clearing members (for the buyer and seller of the futures) complete the same transactions of FIG. 1.

In theory, the clearing member must have double the amount of margin required to handle this substitution. That is, the cash to satisfy the early morning cash payment and the securities to handle the substitution. This is because the substitution does not occur simultaneously. There is a period of time during the day in which the clearinghouse has both the cash and the securities for the original margin requirement, i.e., double the original margin requirement. In practice, the clearing member rarely has the cash available to meet the cash margin requirement because they have invested their cash balances. This results in the clearing members account becoming overdrawn at the margin settlement bank. This arrangement has a number of inefficiencies. First, the overdraft creates an unnecessary credit exposure for the margin settlement bank. Second, it unnecessarily takes away from the overall available credit that the clearing member can obtain for other purposes. Third, as it is becoming increasingly common to be charged for intra-day overdrafts, it creates an unnecessary expense for the clearing member. And fourth, the clearing member also must pay the fees associated with the cash transfer and the pledging of the securities.

The transfer of the variation margin from the clearing member to the clearinghouse also has its inefficiencies. As discussed previously, variation payments net to zero—for every dollar of variation margin collected there is an equal dollar amount of variation margin paid. Clearing members do not necessarily collect its customers variation margin each day. These gains are credited to the customer's account, and generally are only paid to the customer either when requested, when the gains reach a predetermined threshold, or paid on a monthly basis. FIG. 2 is a flow chart that illustrates conventional transactions performed to satisfy a variation margin. Assume in this example that the buyer of a futures contract is owed a variation margin from the seller. Note that the following example works in the same manner if the seller is owed the variation margin.

In Step 50, the buyer requests payment of the variation margin from the seller. In response, the seller's clearing member sells securities to fund the variation margin payments, in Step 60. Accordingly, all clearing members must maintain daily liquidity in order to have daily cash to meet variation margin. In Step 70, the liquidated cash is transferred to the clearinghouse. The clearinghouse then pays the cash to the buyer's clearing member, in Step 80. Finally, the buyer's clearing member reinvests the cash, likely in the same instruments as the seller's clearing member, in Step 90.

As is obvious, the current system of transferring variation margins are highly inefficient. On an individual basis, there are large sums of money moving between individual clearing members and clearinghouses but in the aggregate, there is little daily change in the overall amount of funds and securities allocated to futures trading across the various exchanges. These inefficiencies are compounded by the fact that clearinghouses typically process variation margins late in the day which requires the clearing members to maintain late-day liquidity. Thus, the clearing members cannot predict their final investment activity until late in the day—a period in which the money markets are apt to be less liquid. The result of this late-day investment activity is that the clearing members sacrifice investment returns.

Further, the investment of customer funds, including margins, by either the clearing member or clearinghouse, are conventionally limited to U.S. government and municipal backed securities, such as U.S. Treasury bills.

It is therefore an object of the present invention to streamline the transfer of margin payments.

Another object of the present invention is to improve the investment returns of clearing members and clearinghouses.

A further object of the present invention is to provide an interest bearing instrument that can be used for the investment of customer funds.

An additional object of the present invention is to provide an interest bearing instrument that can be used to satisfy original margin, and substitute for original margin cash payments.

Another object of the present invention is to provide an interest bearing instrument that can be used to satisfy variation margin, and substitute for variation margin cash payments.

Yet another object of the present invention is to reduce the expenses associated with processing variation margin payments.

Various other objects, advantages and features of the present invention will become readily apparent from the ensuing detailed description and the novel features which will be particularly pointed out in the appended claims.

### SUMMARY OF THE INVENTION

Theses and other objects are realized by an interest bearing instrument that can be transferred between buyer's and seller's clearing members, via a clearinghouse, to pay a variation margin. Further, these and other objects are realized by an interest bearing instrument that can be transferred from a clearing member to a clearinghouse to pay an original margin.

Specifically, the present invention is directed to at least one fund, such as a common settlement money market mutual fund, and to a method for improving the efficiency of margining exchange-traded futures contracts and options on futures contracts. Shares of such mutual funds are purchased by a futures commission merchant (FCM) on behalf of its customers (or on behalf of itself). The FCM then transfers at least a portion of the shares to an associated clearing organization or clearinghouse to satisfy a margin requirement of the futures or options contract. The margin requirement, for example, may be for original margin, variation margin, or both.

In another embodiment of the invention, shares are redeemable the same day a redemption request is made by the FCM. Preferably, to guarantee redemption, the request is made by a certain time, such as 3pm EST.

In a further embodiment of the invention, the clearing organization transfers the shares to a second FCM, or to the same FCM, on behalf of a second investor to satisfy a variation margin requirement. The second investor is a party to the futures or options, either as the buyer or seller of the contract.

As another embodiment of the invention, each fund is a spoke of a respective or the same 17 C.F.R. §270.2a-7 compliant money market portfolio hub. Further, each fund preferably complies with 17 C.F.R. §§ 1.25 and 270.2a-7, as a permitted investment for said investor.

As yet an additional aspect, any or all of the above transactions may be performed over the Internet or over a direct link using at least one computerized system.

Such advantages listed above are merely illustrative and not exhaustive. Further, these and other features and advantages of the present invention will become more apparent from the accompanying drawings and the following detailed description.

### BRIEF DESCRIPTION OF THE DRAWINGS

The following detailed description, given by way of example and not intended to limit the present invention solely thereto, where similar elements will be referred to by the same reference symbols, will best be understood in conjunction with the accompanying drawings in which:

FIG. 1 is a flow chart that illustrates conventional payment transactions performed to satisfy an original margin.

FIG. 2 is a flow chart that illustrates conventional payment transactions performed to satisfy a variation margin.

FIG. 3 illustrates a hub and spoke configuration, in accordance with an embodiment of the present invention.

FIG. 4 illustrates one spoke of the hub of FIG. 3, in accordance with an embodiment of the present invention.

FIG. 5 illustrates the FCM account structure of FIG. 4 and associated clearinghouse account structures, in accordance with an embodiment of the present invention.

FIG. 6 illustrates the transfer of cash to a non-pledged customer account of an FCM, in accordance with an embodiment of the present invention.

FIG. 7 illustrates the purchase of shares of the Fund by the FCM of FIG. 6 in exchange for cash, in accordance with an embodiment of the present invention.

FIG. 8 illustrates the pledging of shares by the FCM of FIG. 7 to satisfy a variation margin, in accordance with an embodiment of the present invention.

FIG. 9 illustrates the transfer of shares by the FCM of FIG. 8 to satisfy an original margin, in accordance with an embodiment of the present invention.

FIG. 10 is a flow chart that illustrates the transactions performed to satisfy a variation margin, in accordance with the present invention.

FIG. 11 is a flow chart that illustrates the transactions performed to satisfy an original margin, in accordance with the present invention.

FIG. 12 illustrates a computer implementation to perform the transactions between the FCMs and the clearinghouse, in accordance with an embodiment of the present invention.

### DETAILED DESCRIPTION OF THE INVENTION

Section 1.25 of Title 17 of the Code of Federal Regulations (C.F.R.) sets forth “permitted” investments available to a clearing member (i.e., an FCM) or clearinghouse (i.e., a clearing organization) for investing customer funds. Prior to December 2000, only U.S. government and municipal backed securities, such as U.S. Treasury bills, could be used for the investment of customer funds. However, on Dec. 28, 2000, amended regulation 17 C.F.R. §1.25 became effective. According to amended §1.25, the list of permitted investments now includes: U.S. Treasury Securities (such as bills, notes, bonds & strips); repurchase agreements; Federal Agency securities; commercial paper; certificates of deposit; corporate notes; asset-backed securities; municipal securities; and money market mutual funds. At this time, the only permitted money market mutual funds are funds that comply 17 C.F.R. §270.2a-7 (known as Section 2a7 funds).

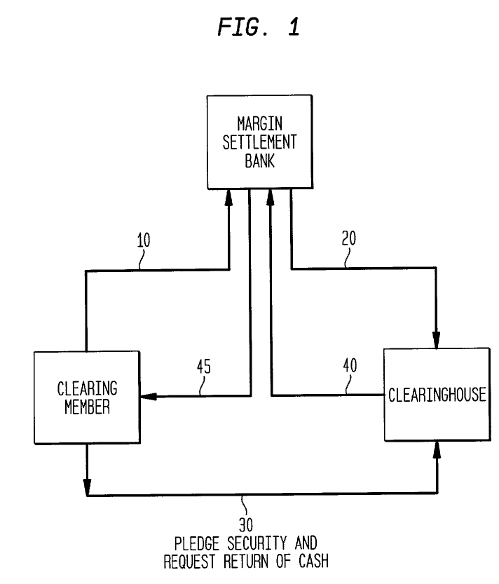

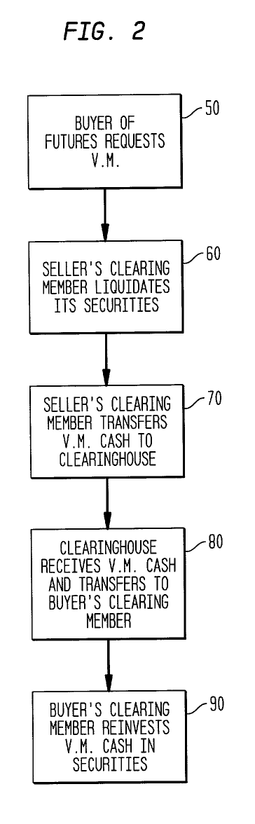

As described above in reference to FIGS. 1 and 2, cash transactions of original and variation margins have been the mainstay of futures exchange-trading. Up to now, investments of these cash margins have been in the realm of U.S. Treasury securities, yielding increasingly poor returns. In response, a novel interest bearing instrument, that can transfer between clearing members and clearinghouses to satisfy original and variation margins, is presented.

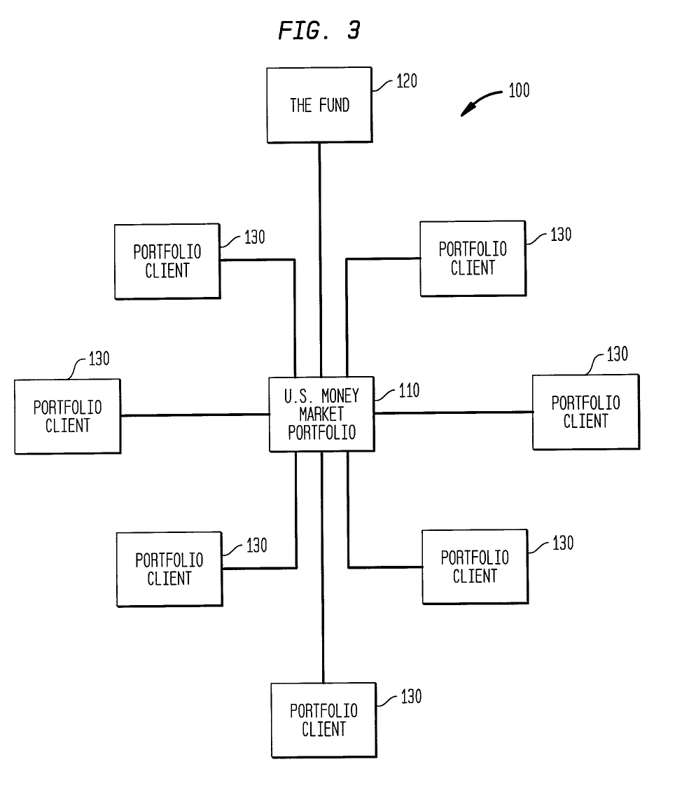

The interest bearing instrument of the invention is preferably shares in one or more common settlement money market mutual funds (hereinafter, “the Fund”) that complies with §§ 1.25 and 270.2a-7, described above. A typical implementation of the Fund, the so-called “hub and spoke” configuration, will now be described. In general, a hub and spoke permits multiple mutual funds with the same investment objectives to form a partnership with each individual fund or “spoke” investing in a common portfolio or “hub.” The hub is where all actual trading activity occurs. U.S. Pat. No. 5,193,056, entitled “Data Processing System for Hub and Spoke Financial Services Configuration,” assigned to Signature Financial Group, Inc. describes one such hub and spoke configuration. The hub and spoke configuration 100, in accordance with the invention, is illustrated in FIG. 3.

In FIG. 3, the hub 110 is a U.S. money market portfolio. For example, the portfolio is preferably registered under the Investment Company Act of 1940, as amended, as a no-load, diversified, open-end management investment company. Further, portfolio hub 110 preferably complies with Section 2a7.

Configuration 100 also includes spokes 120 and 130. As described above, each spoke shares the same investment objectives as the portfolio hub. Spoke 120 is the above described Fund, while multiple spokes 130 are individual client accounts and funds that utilize the portfolio hub 110. Such spokes 130 may be, e.g., publically traded or private investment companies. Note that under current regulations, hub 110 is only permitted to have 99 total spokes. As stated, the interest bearing instrument of the invention may include shares from more than one common settlement money market mutual fund. For example, the shares may be bought from two fund spokes of one portfolio hub, two fund spokes of two different portfolio hubs, and so on.

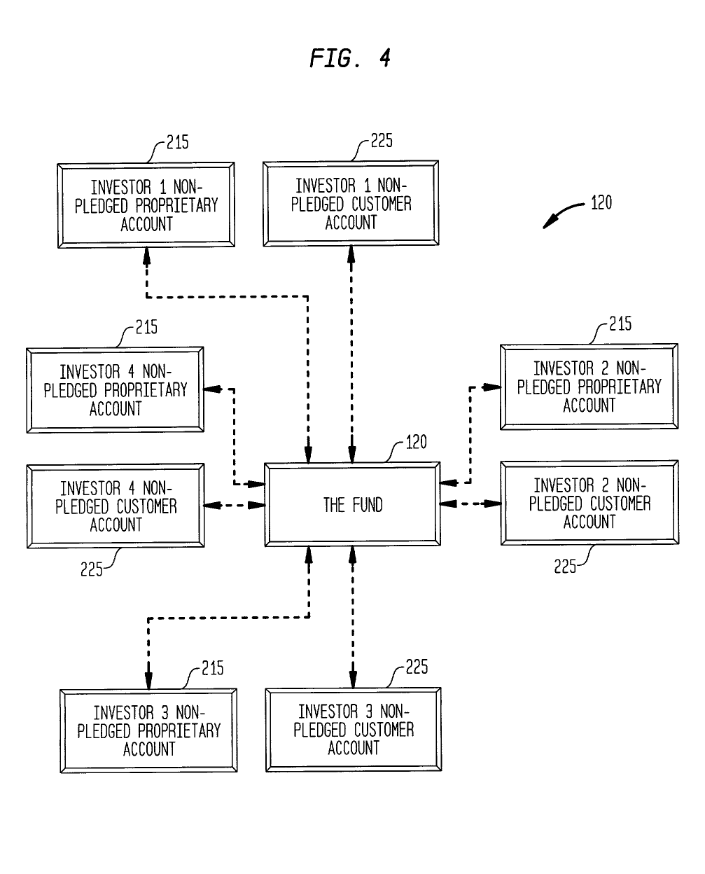

FIG. 4 illustrates spoke 120 of hub 110. Specifically, it shows an illustrative FCM account structure that may be used in accordance with the present invention. Four FCM investors 1-4 (e.g., Merrill Lynch, Goldman Sachs, etc.) of the Fund are shown, where each FCM investor has at least two non-pledged bank cash/custody accounts. These illustrated accounts are non-pledged proprietary accounts 215, and non-pledged customer accounts 225. Note that there may be additional non-pledge accounts, such as guaranty fund accounts for each FCM. Proprietary accounts 215 hold the commingled assets (e.g., shares in the Fund and possibly other cash) of the FCM, when the FCM acts as its own customer. Customer accounts 225 hold the commingled assets of the FCM's non-member customers. Although the assets of all customers are commingled, a separate accounting (not shown) is kept for each individual customer.

All accounts 215, 225 are owned and controlled by each respective FCM investor. Although the customers do not actually own title in the shares in the Fund held in the FCM's customer account, the customers have a legal claim against the account, should the FCM default or commit wrongdoing.

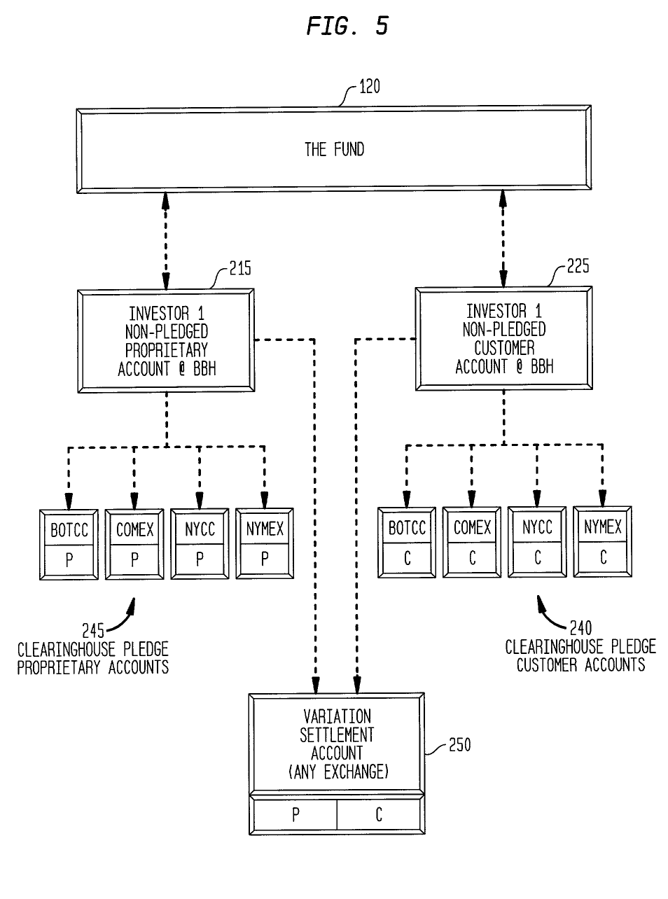

FIG. 5 illustrates FCM account structure of FIG. 4 with illustrative clearinghouse account structures, according to the invention. Specifically, clearinghouse pledge customer accounts 240 and clearinghouse pledge proprietary accounts 245 are illustrated. Note that there may be additional pledge accounts, such as guaranty fund accounts for each clearinghouse. As shown, the following futures exchange clearinghouses are associated with FCM 1: Board of Trade Clearing Corporation (BOTCC); Comex Clearing Corporation (COMEX); New York Clearing Corporation (NYCC); and New York Mercantile Exchange (NYMEX). Similar to FCM proprietary account 215, each clearinghouse proprietary account “P” holds all proprietary funds of the associated FCM (FCM investor 1, as shown), as such funds are transferred. Likewise, each clearinghouse customer account “C” holds all customer funds of said FCM, as such funds are transferred. Each pledge account is under the control of the respective clearinghouse for the benefit of the associated FCM. Although each pledge account is under the control of the respective clearinghouse, the FCM remains the legal owner of the shares; however, the clearinghouse has a legal claim against them.

In addition, the non-pledged proprietary and customer accounts 215, 225 are also linked to a proprietary and customer variation settlement account 250 for each associated clearinghouse. Although only one variation settlement account 250 is shown for clarity, there is preferably a respective variation settlement account (proprietary and customer) for each clearinghouse. Unlike shares that are pledged from the FCMs non-pledged accounts 215, 225 to the pledge accounts 240, where ownership of the shares remains with FCM 1, when there is a variation margin call from a customer Y of another FCM (say, FCM investor 2), the shares and ownership thereof are transferred to FCM 2. Of course, if both customers X and Y are associated with FCM 1, then ownership does not transfer.

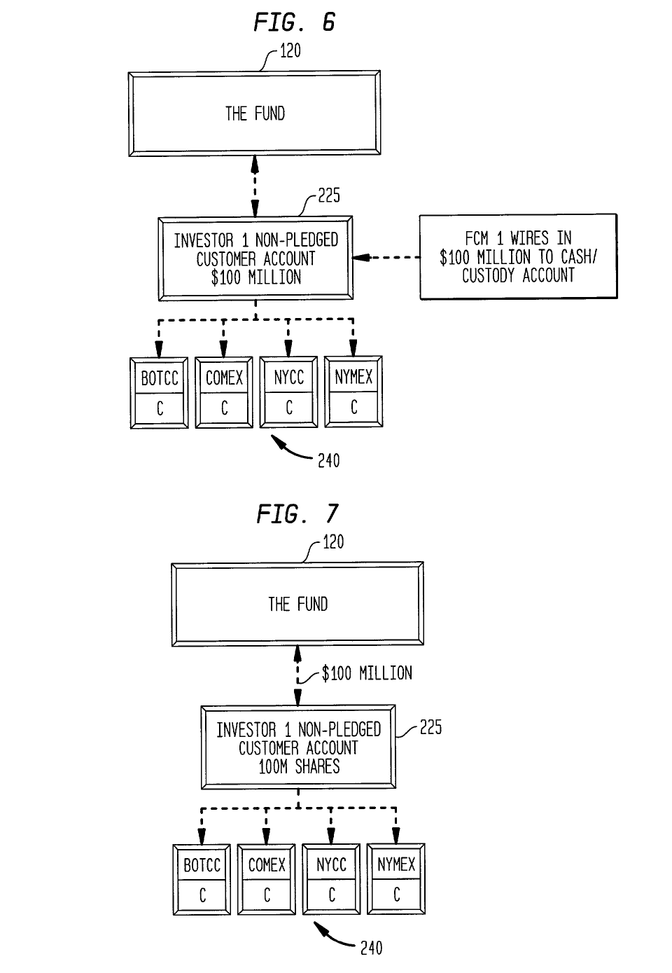

An example of margin payment transactions utilizing the Fund is now described with reference to FIGS. 6-9. Note that FIGS. 6-9 shows the investment/custody function for one of the two FCM investor accounts, i.e., the customer account 225. However, transactions using the proprietary account 215 are substantially identical.

First assume that a large customer X wires $100 million in cash to FCM investor 1 (“FCM 1”) for forthcoming futures and options trades (not shown). FCM 1 then transfers in the $100 million customer cash into its commingled customer account 225, as shown in FIG. 6. As described above, this account is maintained with the FCM. Note that customer X will typically be earning interest of the $100 million based only on, e.g., the yield of the current 90-day U.S. Treasury bill. Thus, any equity earned over the yield of the 90-day Treasury bill (e.g., from investing in the Fund) is profit for the FCM.

FIG. 7 illustrates the purchase of $100 million worth of shares from the Fund by the FCM, where each share has a price of, e.g., $1. For example, FCM 1 will contact the trading desk of the Fund (e.g., over the Internet or by telephone) to purchase the Fund shares. Specifically, the $100 million in cash is exchanged for 100 million shares of the Fund, and is held in non-pledged customer account 225. Note that with the hub and spoke configuration, the shares of the Fund represents a pro-rata equity interest in the securities owned by the portfolio hub 110. As stated earlier, the FCM may also purchase shares of other funds within or out of hub 110 (not shown).

As an advantage of the inventive Fund, the FCM has a right of redemption of any and all shares that it holds in its non-pledged proprietary and customer accounts 215, 225. In fact, one of the benefits of the Fund is that the shares are extremely liquid. That is, they can be redeemed the same day (if a redemption request is made by a certain time, e.g., 3pm EST); otherwise, it is redeemed by best-efforts. At worst, they will be redeemed first thing the next morning.

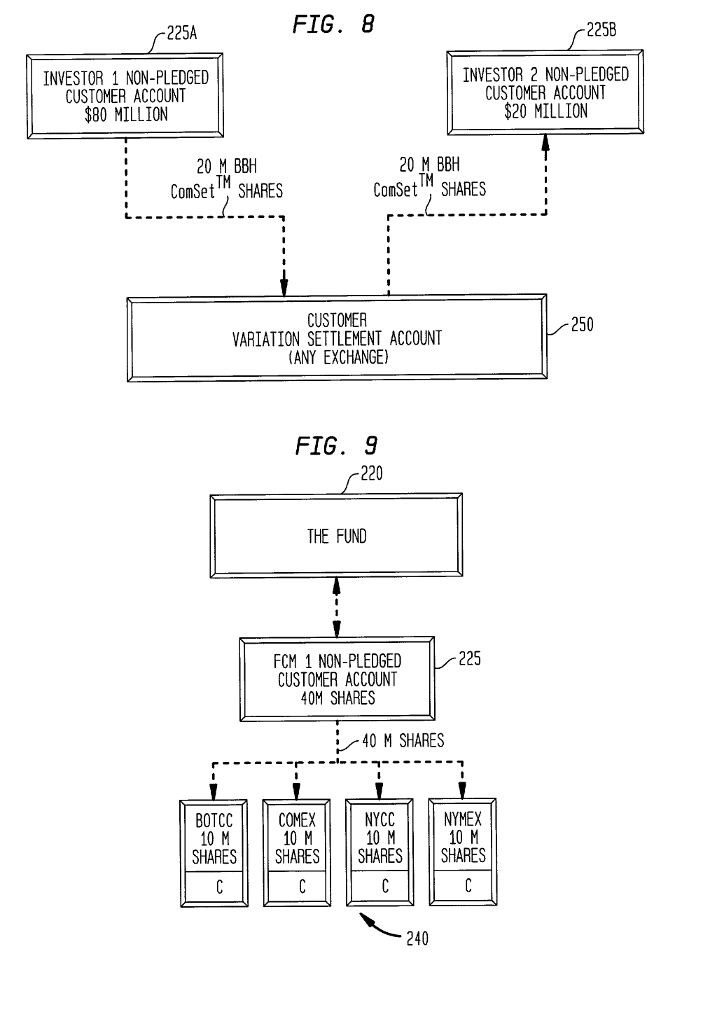

Let us assume, with reference to FIG. 8, that FCM 1 receives instructions from an associated clearinghouse (e.g., COMEX) of a variation margin call for $20 million (not shown). It is important to appreciate that the variation margin call may be for a marked-to-market loss of customer X (from, e.g., a prior futures trade) or from any customer of FCM 1. As shown in FIG. 8, 20 million shares of the Fund are transferred from FCM 1's commingled customer account 225A (leaving 80 million shares) to the customer variation settlement account 250 of COMEX. Note that these shares are not merely pledged. That is, ownership is transferred as well. Thereafter, the 20 million shares are transferred, along with ownership, to non-pledged customer account 225B of FCM investor 2. Accordingly, FCM 1 now accrues interest from the Fund on the remaining 80 million shares, while FCM 2 accrues interest from the Fund on the 20 million shares. Assuming the Fund is performing well, both FCMs should achieve a higher rate of return as compared to the current 90-day Treasury bill. As stated, the amount that the Fund outperforms the Treasury bill is equity for the FCMs.

Recall the transaction described in FIG. 2, where the seller's FCM (investor 1) liquidates its securities to cash, transfers the cash from the FCM to the clearinghouse, transfers the cash from the clearinghouse to the buyer's FCM (investor 2), and reinvests, by the buyer's FCM, the cash into securities. As should be obvious, the transaction of FIG. 8 streamlines the process, avoids fees involved in liquidating and reinvesting, and keeps the margin in a potentially high yielding mutual fund.

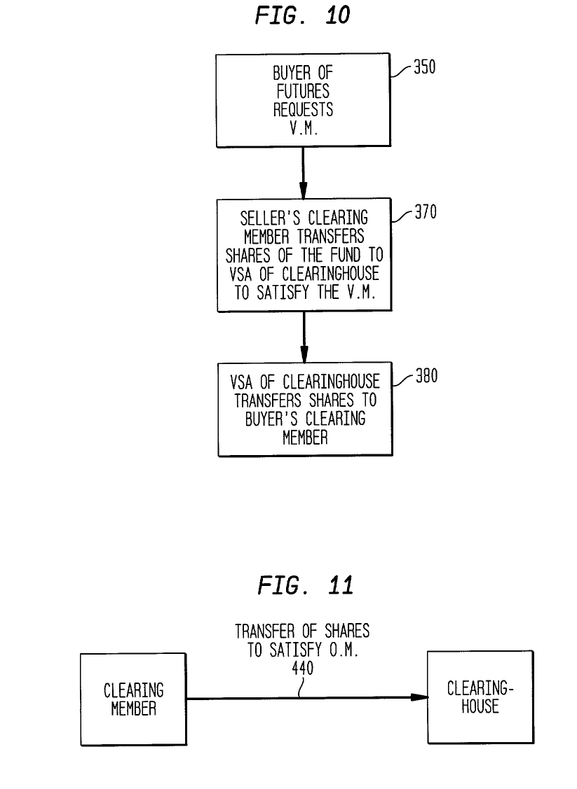

FIG. 10 is a flow chart that illustrates the transactions, e.g., of FIG. 8, to satisfy a variation margin, in accordance with the present invention. This may be compared to the conventional transaction illustrated in FIG. 2. In FIG. 10, assume that the buyer of a futures contract is owed a variation margin from the seller.

In Step 350, the buyer requests payment of the variation margin. In response, shares of the Fund are simply transferred from the non-pledged customer account of the buyer's FCM to the customer variation settlement account of the associated clearinghouse (the clearinghouse that traded the subject futures), in step 370. Lastly, the shares are transferred from the variation settlement account to the non-pledged customer account of the buyer's clearing member, in Step 380.

Now let us assume, with reference to FIG. 9, that the FCM receives instructions from each clearinghouse (BOTCC, COMEX, NYCC, and NYMEX) that a $10 million original margin is required for a respective position (e.g., a futures contract) or many respective positions, entered into by the FCM 1 with each clearinghouse (not shown). As previously mentioned, these positions may be for the benefit of the FCM's customers or for the FCM itself. In this example, we will assume that the positions, requiring a $10 million original margin at each clearinghouse, are for various customers of FCM 1. Accordingly, 10 million shares are pledged from customer account 225 to each of the customer pledge accounts 240. Since we began with 80 million shares in account 225 (recall 20 million shares were transferred in FIG. 8), 40 million shares now remain in customer account 225 for future trades and margin requirements, as desired.

Accordingly, the FCM now accrues equity from the Fund on the remaining 40 million shares (less the interest earned based on the 90-day Treasury bill). Further, each clearinghouse (BOTCC, COMEX, NYCC, and NYMEX) earns substantially all of the equity earned from the 10 million shares of the Fund it holds as original margin. As described, the clearinghouses do not typically return any interest to the FCM. Recall the transaction described in FIG. 1, where cash first transferred between the FCM's and the clearinghouse's accounts in a margin settlement bank. Thereafter, the FCM would pledge a security and request the cash back, thus requiring that the FCM have “double the amount of margin.” However, the transaction of FIG. 9 streamlines the process, avoids the double margin necessity of the FCM, and keeps the margin in a high yielding mutual fund for the clearinghouse.

FIG. 11 is a flow chart that illustrates the transactions, e.g., of FIG. 9, to satisfy an original margin, in accordance with the present invention. This may be compared to the conventional transaction of FIG. 1. In Step 410, shares of the Fund are simply transferred from the clearing member (e.g., from the non-pledged customer account) to the clearinghouse (e.g, to the pledged customer account).

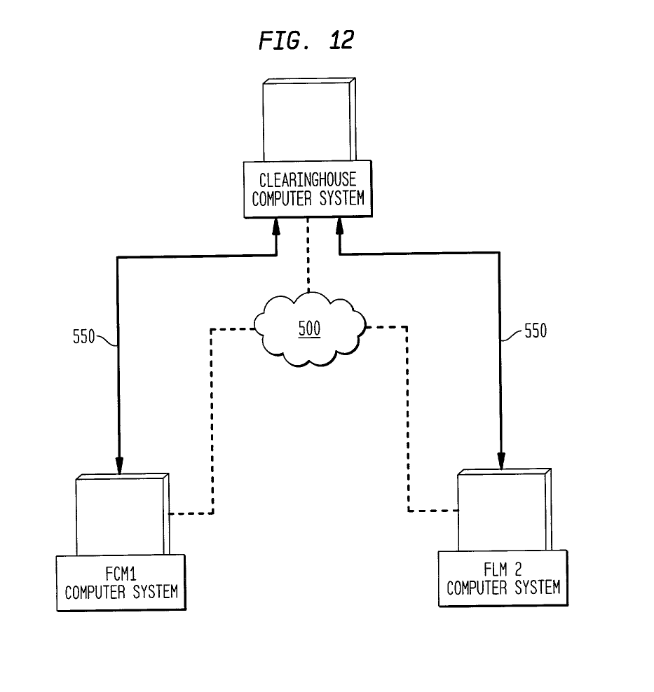

Illustratively, the transactions shown in FIGS. 3-11 may be implemented by the FCM and clearinghouse computer systems, shown in FIG. 12. As shown, the transactions may be made from a respective computer system over the Internet 500 or over hard-wired connections 550.

It should be understood that the foregoing description is merely illustrative of the invention. Numerous alternative embodiments within the scope of the appended claims will be apparent to those of ordinary skill in the art.

What is claimed is:

1. A method of improving the efficiency of margining exchange-traded futures and options on futures contracts, the method comprising the steps of:
(a) purchasing, by a futures commission merchant (FCM) on behalf on a customer, shares of at least one fund; and
(b) transferring, by said FCM on behalf on said customer, at least a portion of said shares to an associated clearing organization, to satisfy a margin requirement of a futures or options contract entered into by said customer and traded through said associated clearing organization.

2. The method of claim 1, wherein title in said shares purchased by said FCM are owned by said FCM.

3. The method of claim 1, wherein the value of said at least a portion of said shares substantially equals the value of said margin requirement.

4. The method of claim 1, further comprising the step of:
(c) transferring, by said FCM on behalf on said customer, at least one of cash and securities to said associated clearing organization, to satisfy said margin requirement together with said at least a portion of said shares,
wherein the value of said at least a portion of said shares and the value of said at least one of cash and securities substantially equals the value of said margin requirement.

5. The method of claim 1, wherein said shares are redeemable for cash the same day a redemption request is made.

6. The method of claim 1, wherein said shares are redeemable for cash the same day a redemption request is made, until a predetermined time of said day.

7. The method of claim 1, wherein said margin requirement is an original margin requirement.

8. The method of claim 1, wherein said margin requirement is a variation margin requirement.

9. The method of claim 1, wherein step (a) further comprises the step of:
(a1) holding the purchased shares into a non-pledged account, wherein said non-pledged account is owned by said FCM.

10. The method of claim 7, wherein step (b) further comprises the step of:
(b1)holding the transferred shares into a pledged account, wherein said pledged account is owned by said clearing organization on behalf of said FCM, and wherein title in said shares remains with said FCM.

11. The method of claim 8, further comprising the step of:
(c) transferring, by said associated clearing organization, said at least a portion of said shares to satisfy said variation margin requirement.

12. The method of claim 11, wherein said transferring in step (c) transfers said shares to a second FCM on behalf of a second customer, wherein said second customer is a party to said futures or options contract, and wherein title is said shares transfers to said second FCM.

13. The method of claim 11, wherein said transferring in step (c) transfers said shares to said FCM on behalf of a second customer, wherein said second customer is a party to said futures or options contract.

14. The method of claim 7, further comprising the step of:
(c) transferring, by said FCM, additional said shares to satisfy a second margin requirement.

15. The method of claim 14, wherein said second margin requirement is a variation margin requirement.

16. The method of claim 14, wherein said second margin requirement is an original margin requirement of a second futures or options contract entered into by said customer.

17. The method of claim 1, wherein said customer is said FCM.

18. The method of claim 1, wherein at least one of said at least one fund is a spoke of a money market portfolio hub.

19. The method of claim 1, wherein each of said at least one fund is a spoke of a different money market portfolio hub.

20. The method of claim 18, wherein said money market portfolio hub complies with 17 C.F.R. §270.2a-7.

21. The method of claim 1, wherein at least one of said at least one find is a common settlement money market fund.

22. The method of claim 21, wherein said money market fund complies with 17 C.F.R. §270.2a7.

23. The method of claim 22, wherein said money market fund further complies with 17 C.F.R. §1.25 as a permitted investment for said customer.

24. The method of claim 9, further comprising the step of:
(a1) earning, by said FCM, equity on each of said shares held by said FCM.

25. The method of claim 9, further comprising the step of:
(a1) earning, by said FCM, equity on each of said shares held by said FCM less interest determined from a current reference yield.

26. The method of claim 25, wherein said current reference yield is a current yield of a predetermined government treasury bill.

27. The method of claim 10, further comprising the step of:
(b2) earning, by said clearing organization, equity on each said at least a portion of said shares held by said clearing organization.

28. The method of claim 1, wherein steps (a) and (b) may be performed over one of the Internet and direct link using at least one computerized system.

29. At least one fund for improving the efficiency of margining exchange-traded futures and options on futures contracts, the fund comprising:
shares in said at least one fund; and
fund guidelines of said at least one fund, said guidelines including a requirement that said shares are to be purchased by at least one futures commission merchant (FCM) on behalf on a customer;
wherein at least a portion of said shares are transferred, by said FCM on behalf on said customer, to an associated clearing organization, to satisfy a margin requirement of a futures or options contract entered into by said customer and traded through said associated clearing organization.

30. The fund of claim 29, wherein titles in said shares purchased by said FCM are owned by said FCM.

31. The fund of claim 29, wherein the value of said at least a portion of said shares substantially equals the value of said margin requirement.

32. The fund of claim 29, wherein at least one of cash and securities are transferred, by said FCM on behalf on said customer, to said associated clearing organization, to satisfy said margin requirement together with said at least a portion of said shares, and
wherein the value of said at least a portion of said shares and the value of said at least one of cash and securities substantially equals the value of said margin requirement.

33. The fund of claim 29, wherein said shares are redeemable for cash the same day a redemption request is made.

34. The fund of claim 29, wherein said shares are redeemable for cash the same day a redemption request is made, until a predetermined time of said day.

35. The fund of claim 29, wherein said margin requirement is an original margin requirement.

36. The fund of claim 29, wherein said margin requirement is a variation margin requirement.

37. The fund of claim 29, wherein the shares purchased by said FCM are held in a non-pledged account, wherein said non-pledged account is owned by said FCM.

38. The fund of claim 35, wherein the shared transferred to said clearing organization are held in a pledged account, wherein said pledged account is owned by said clearing organization on behalf of said FCM, and wherein title in said shares remains with said FCM.

39. The fund of claim 36, wherein said at least a portion of said shares are transferred from said associated clearing organization to satisfy said variation margin requirement.

40. The fund of claim 39, wherein the shares transferred from said associated clearing organization are delivered to a second FCM on behalf of a second customer, wherein said second customer is a party to said futures or options contract, and wherein title in said shares transfers to said second FCM.

41. The fund of claim 39, wherein the shares transferred from said associated clearing organization are delivered to said FCM on behalf of a second customer, wherein said second customer is a party to said futures or options contract.

42. The fund of claim 35, wherein additional said shares are transferred by said FCM to satisfy a second margin requirement.

43. The fund of claim 42, wherein said second margin requirement is a variation margin requirement.

44. The fund of claim 42, wherein said second margin requirement is an original margin requirement of a second futures or options contract entered into by said customer.

45. The fund of claim 29, wherein said customer is said FCM.

46. The fund of claim 29, wherein at least one of said at least one fund is a spoke of a money market portfolio hub.

47. The fund of claim 29, wherein each of said at least one fund is a spoke of a different money market portfolio hub.

48. The fund of claim 46, wherein said money market portfolio hub complies with 17 C.F.R. §270.2a-7.

49. The fund of claim 29, wherein at least one of said at least one fund is a common settlement money market fund.

50. The fund of claim 49, wherein said money market fund complies with 17 C.F.R. §270.2a-7.

51. The fund of claim 50, wherein said money market fund further complies with 17 C.F.R. §1.25 as a permitted investment for said customer.

52. The fund of claim 37, wherein said FCM earns equity on each of said shares held by said FCM.

53. The fund of claim 37, wherein said FCM earns equity on each of said shares, held by said FCM, less interest determined from a current reference yield.

54. The fund of claim 53, wherein said current reference yield is a current yield of a predetermined government treasury bill.

55. The fund of claim 38, wherein said clearing organization earns equity on each of said at least a portion of said shares held by said clearing organization.

56. The fund of claim 29, wherein said shares are purchased and transferred over one of the Internet and direct link using at least one computerized system.

57. A common settlement fund for use in settling margins in connection with exchange-traded futures contracts or exchange-traded options on futures contracts, comprising:
shares of said fund, said shares are owned by a future commission merchants (FCM) on behalf of its customers,
wherein margin related transactions of futures contracts or options on futures contracts are settled by transferring shares from said FCM to a clearing organization.

58. A method of utilizing a common settlement fund to settle margins in connection with exchange-traded futures contracts or exchange-traded options on futures contracts, wherein said fund includes shares that are owned by a futures commission merchants (FCM) on behalf of its customers, said method comprising the step of:
transferring shares from said FCM to a clearing organization to settle margin related transactions of futures contracts or options on futures contracts.
